(19) United States
(12) Patent Application Publication
(10) Pub. No.: US 2008/0170199 A1
(43) Pub. Date: Jul. 17, 2008

(54) Eyeglass Frame Temple Arm Incorporating Decorative Article

(76) Inventor: Haim Cohen, Barendrecht (NL)

Correspondence Address: MICHAEL I KROLL, 171 STILLWELL LANE, SYOSSET, NY, 11791, US

(21) Appl. No.: 11/622,431

(22) Filed: Jan. 11, 2007

(51) Int. Cl. G02C 11/02

(52) U.S. Cl. 351/52

(57) ABSTRACT

Disclosed is an interchangeable decorative article for selective placement within an eyeglass frame temple arm by forming one or more transverse apertures within one or both of the temple arms for receiving and fixing the decorative article in a selectively replaceable manner. The aperture and decorative article form a detachable mechanical bond through a flexi-pin assembly comprising opposing spring-loaded spherical bullets that reciprocate and withdraw into the decorative article during insertion into and extraction from the temple arm aperture. The spring exerts a bias urging the bullets outward but are refused egress by a retaining lip. The bullets remain in that position when in the static condition and the spherical properties of the bullets allow for retraction upon contacting the walls of the temple arm aperture as the user pushes the decorative article therein. Each bullet has a mating recess disposed in the interior walls of the temple arm aperture and upon alignment therewith, projects therein where it remains until enough force is applied to the decorative article to retract the bullets for removal.

### BACKGROUND OF THE INVENTION

### Field of the Invention

The present invention relates generally to eyeglass frames and, more specifically, to a means of attaching a decorative article to an eyeglass frame temple arm by forming one or more transverse apertures within one or both of the temple arms for receiving and fixing the decorative article in a selectively replaceable manner.

The decorative article or articles can be a bead, semi-precious stone(s) or precious stone(s) sized to fit within the temple aperture.

The aperture and decorative article form a detachable mechanical bond through a flexi-pin assembly comprising opposing spring-loaded spherical bullets that reciprocate and withdraw into the decorative article during insertion into and extraction from the temple arm aperture. The spring exerts a bias urging the bullets outward but are refused egress by a retaining lip. The bullets remain in that position when in the static condition and the spherical properties of the bullets allow for retraction upon contacting the walls of the temple arm aperture as the user pushes the decorative article therein. Each bullet has a mating recess disposed in the interior walls of the temple arm aperture and upon alignment therewith, projects therein where it remains until enough force is applied to the decorative article to retract the bullets for removal.

Furthermore, the temple arm aperture can be fabricated in a variety of shapes and may include a decorative cuff, such as metallic, surrounding the perimeter of the aperture.

### SUMMARY OF THE PRESENT INVENTION

A primary object of the present invention is to provide eyeglass frames having a temple arm with an aperture for placing a decorative article therein.

Another object of the present invention is to provide eyeglass frames wherein the decorative article is selectively removable.

Yet another object of the present invention is to provide eyeglasses wherein the decorative article and temple arm aperture have at least one matingly engageable surface.

Yet another object of the present invention is to provide eyeglass frames wherein the decorative article includes at least one throughbore extending therethrough for permanently receiving a flexi-pin comprising a spring member that provides a bias against spheres (hereinafter referred to as bullets) located on each end thereof to urge the bullets outward where they retained by a lip after partially exiting therefrom. The bullets retract into the throughbore when the bias presented by the spring is overcome by an opposing bias.

Another object of the present invention is to provide eyeglass frames wherein inner walls of the temple arm aperture have mating recesses for receiving their respective bullets.

Yet another object of the present invention is to provide eyeglass frames wherein the mechanical bond between the decorative article and the temple arm is formed upon insertion of the decorative article into the aperture which is appropriately sized for receiving the article but forces the bullets to retract until aligned with their respective recesses and urged therein by the spring member thus effectively retaining the article therein until a force is applied to the side thereof.

Still another object of the present invention is to provide eyeglass frames wherein the temple arm apertures have decorative cuffs to further enhance the aesthetic properties thereof.

Still yet another object of the present invention is to provide eyeglass frames wherein the decorative article may be rotative.

Additional objects of the present invention will appear as the description proceeds.

The foregoing and other objects and advantages will appear from the description to follow. In the description reference is made to the accompanying drawings, which forms a part hereof, and in which is shown by way of illustration specific embodiments in which the invention may be practiced. These embodiments will be described in sufficient detail to enable those skilled in the art to practice the invention, and it is to be understood that other embodiments may be utilized and that structural changes may be made without departing from the scope of the invention. In the accompanying drawings, like reference characters designate the same or similar parts throughout the several views.

The following detailed description is, therefore, not to be taken in a limiting sense, and the scope of the present invention is best defined by the appended claims.

### BRIEF DESCRIPTION OF THE DRAWING FIGURES

In order that the invention may be more fully understood, it will now be described, by way of example, with reference to the accompanying drawing in which:

FIG. 1 is a perspective view of the present invention with the decorative article removed;

FIG. 2 is a detailed view of the present invention taken from FIG. 1 as indicated;

FIG. 3 is a perspective view of the present invention with the decorative article installed;

FIG. 4 is a detailed view of the present invention taken from FIG. 3 as indicated;

FIG. 5 is a sectional side view of the present invention taken from FIG. 4 as indicated;

FIG. 6 is a sectional side view of the decorative article;

FIG. 7 is a sectional side view of the decorative article; and

FIG. 8 is a sectional side view of the decorative article.

### DESCRIPTION OF THE REFERENCED NUMERALS

Turning now descriptively to the drawings, in which similar reference characters denote similar elements throughout the several views, the Figures illustrate the Eyeglass Frame Temple Arm Incorporating Decorative Article of the present invention. With regard to the reference numerals used, the following numbering is used throughout the various drawing figures.
10 Eyeglass Frame Temple Arm Incorporating Decorative Article
12 eyeglass frame
14 temple arm
16 transverse temple arm aperture
18 aperture wall
20 recess of 18
22 decorative article
24 bullet
26 spring
28 retaining lip
30 throughbore of 22
32 bullet assembly
34 housing of 32

### DETAILED DESCRIPTION OF THE PREFERRED EMBODIMENT

The following discussion describes in detail one embodiment of the invention (and several variations of that embodiment). This discussion should not be construed, however, as limiting the invention to those particular embodiments, practitioners skilled in the art will recognize numerous other embodiments as well. For definition of the complete scope of the invention, the reader is directed to appended claims.

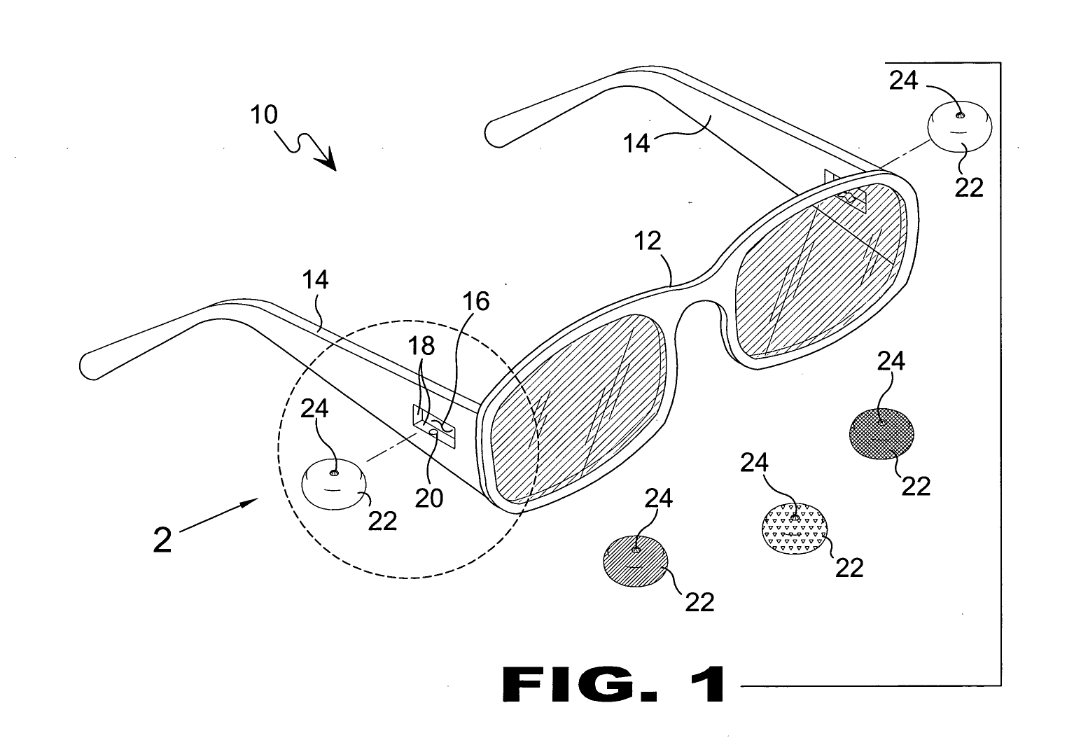

Referring to FIG. 1, shown is an illustrative view of the present invention 10. The present invention 10 is an interchangeable decorative article 22 for the temple arm 14 of eyeglass frames 12. At least one transverse aperture 16 is disposed in at least one temple arm 14 for receiving the decorative article 22 therein. The decorative article 22 has reciprocating bullets 24 on opposing sides thereof that extend into mating recesses 20 in the interior walls 18 of the transverse aperture 16 to retain it therein. The decorative article 22 could be available in a plurality of colors and patterns thus enabling the user to accessorize the eyeglass frames accordingly 12.

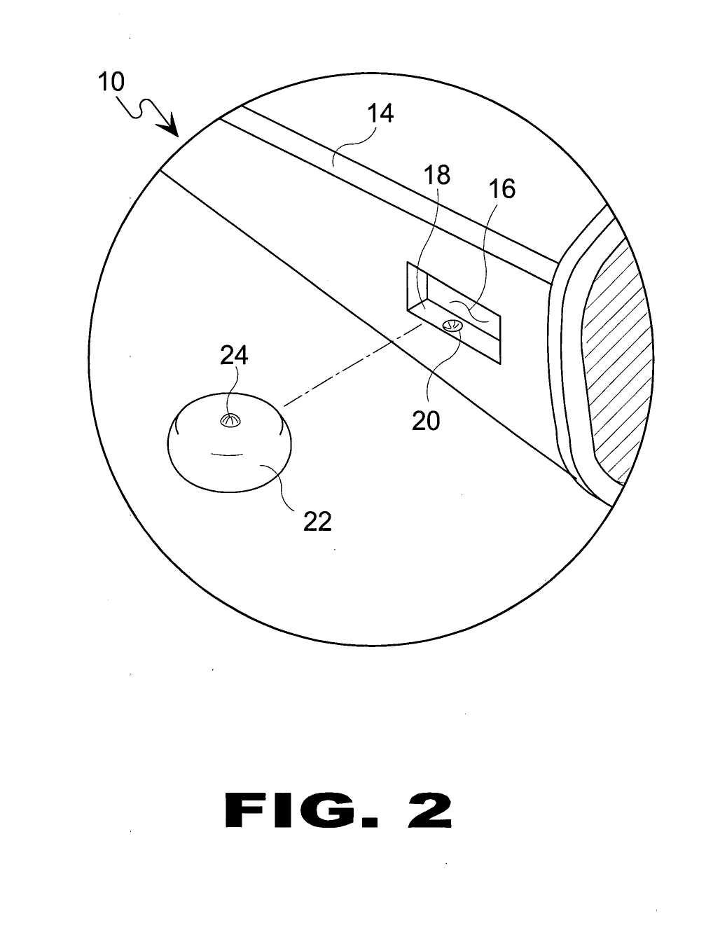

Referring to FIG. 2, shown is a detailed view of the present invention 10 taken from FIG. 1 as indicated. The illustration demonstrates the spatial relation between the decorative article 22 and the transverse aperture 16 in the temple arm 14. Also shown is the upper bullet 24 and the lower recess 20 in the bottom interior wall 18.

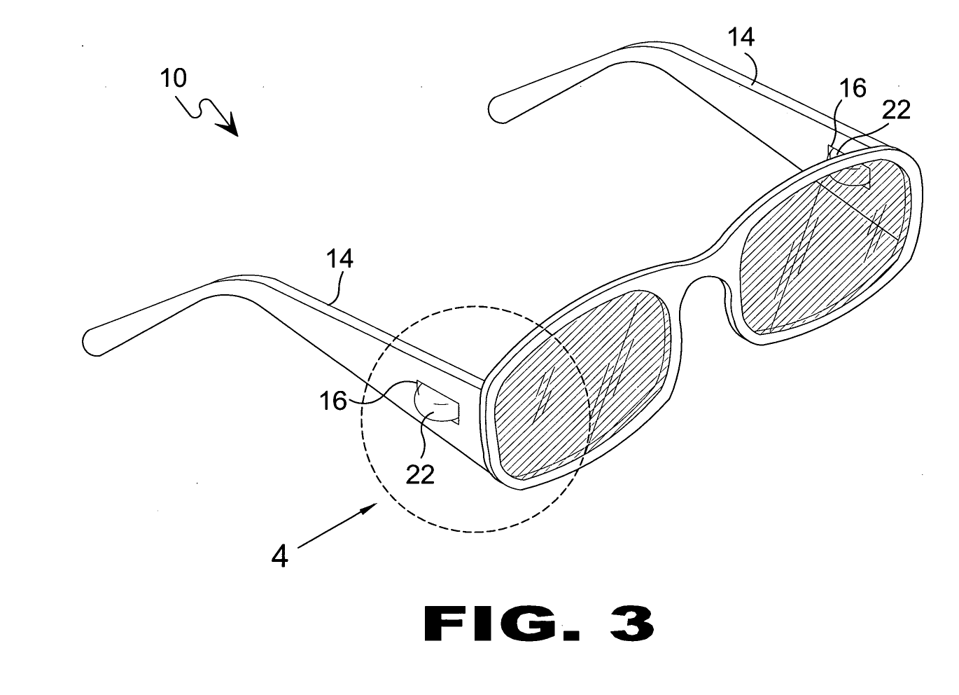

Referring to FIG. 3, shown is an illustrated view of the present invention 10 with the decorative article 22 installed within the transverse aperture 16 of the temple arm 14. The decorative article 22 is frictionally mounted within the transverse aperture 16 thereby enabling the user to install or remove it simply by applying sufficient pressure to its side to overcome the spring bias urging the bullets into their mating aperture wall recesses.

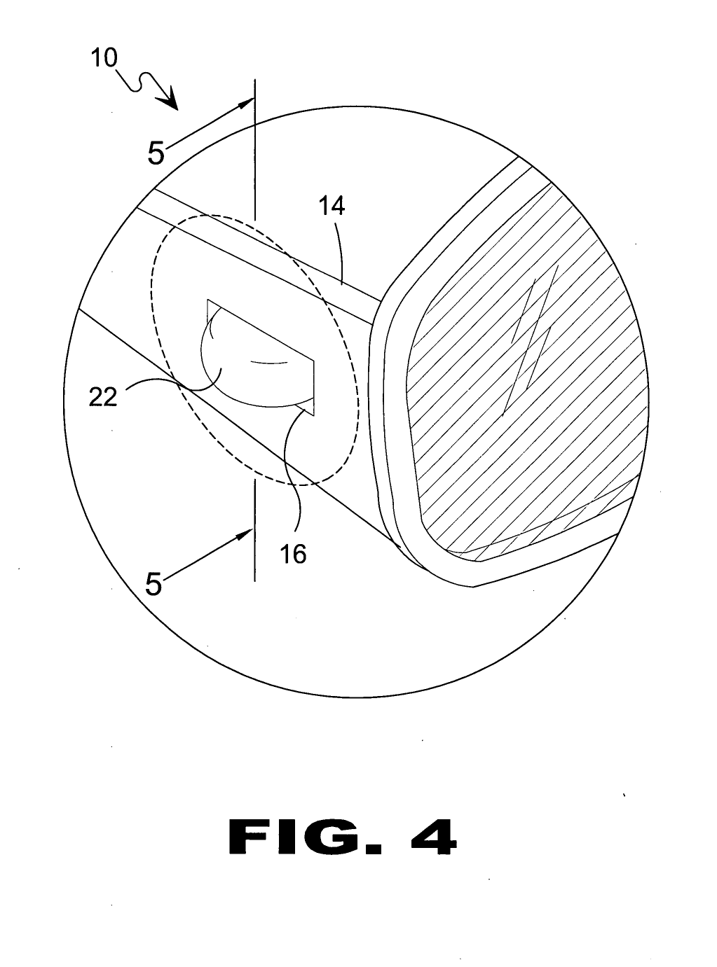

Referring to FIG. 4, shown is a detailed view of the present invention 10 taken from FIG. 3 as indicated with the decorative article 22 installed within the transverse aperture 16 of the temple arm 14.

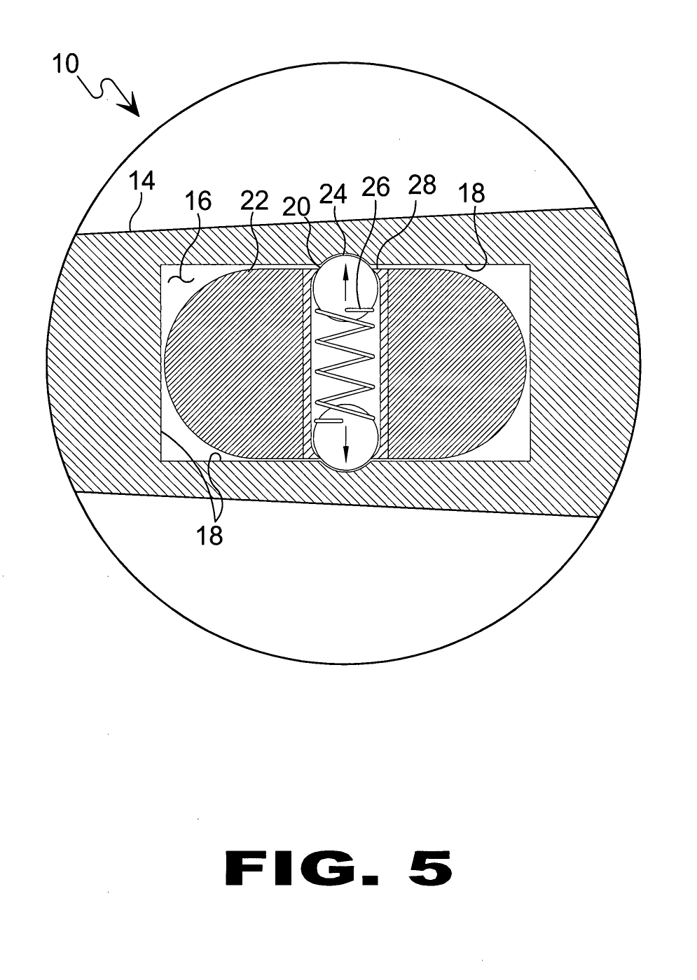

Referring to FIG. 5, shown is a sectional side view of the present invention 10 with a decorative article 22 installed in the transverse aperture 16 to demonstrate the components for the frictional bonding therebetween. The bullets 24 have been aligned with their mating recesses 20 in the upper and lower aperture walls 18 and the spring 26 has applied a bias urging them therein.

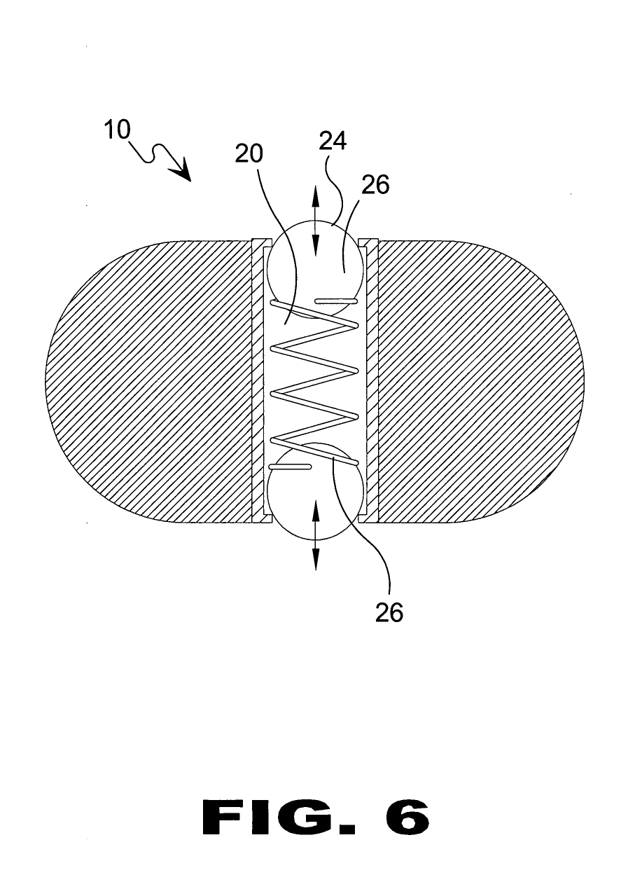

Referring to FIG. 6, shown is an illustrated view of the present invention 10 with the decorative article 22 installed within the transverse aperture 16 of the temple arm 14. The decorative article 22 is frictionally mounted within the transverse aperture 16 thereby enabling the user to install or remove it simply by applying sufficient pressure to its side to overcome the spring bias urging the bullets into their mating aperture wall recesses.

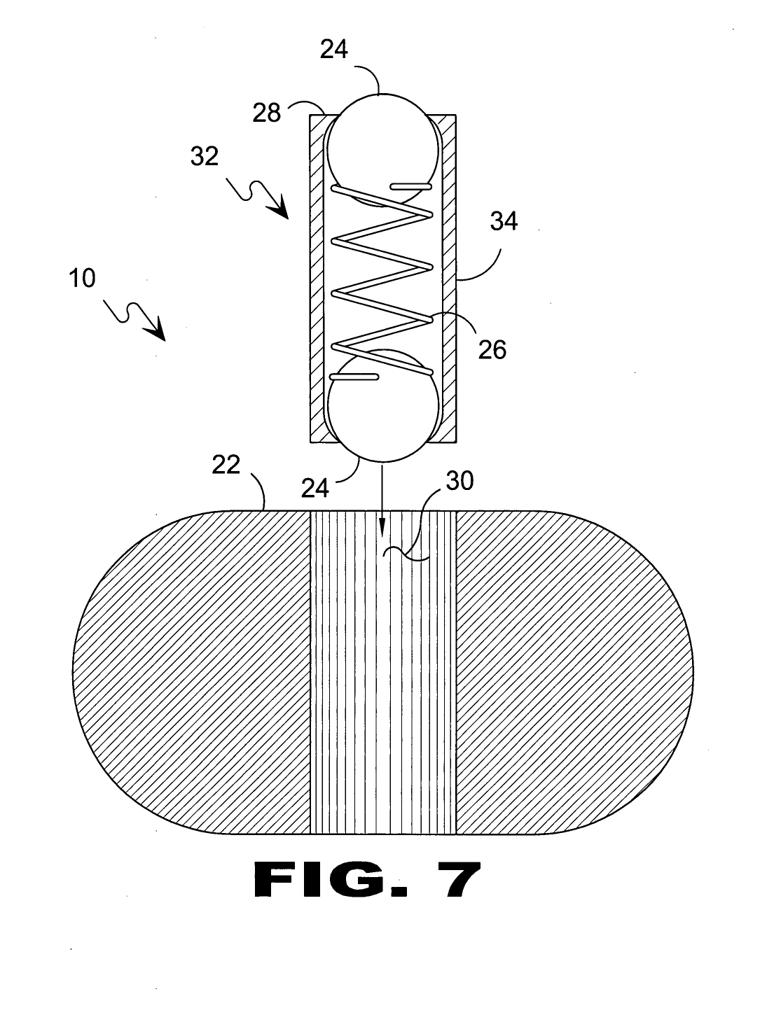

Referring to FIG. 7, shown is a detailed view of the decorative article 22 of the present invention 10. Shown is a version with a pre-assembled bullet assembly 32 during the manufacturing process. The bullets 24 and the spring 26 are contained within housing 34 by the retaining lips 28 thereof. The bullet assembly 32 is inserted into the throughbore 30 of the decorative article 22 and bonded therein.

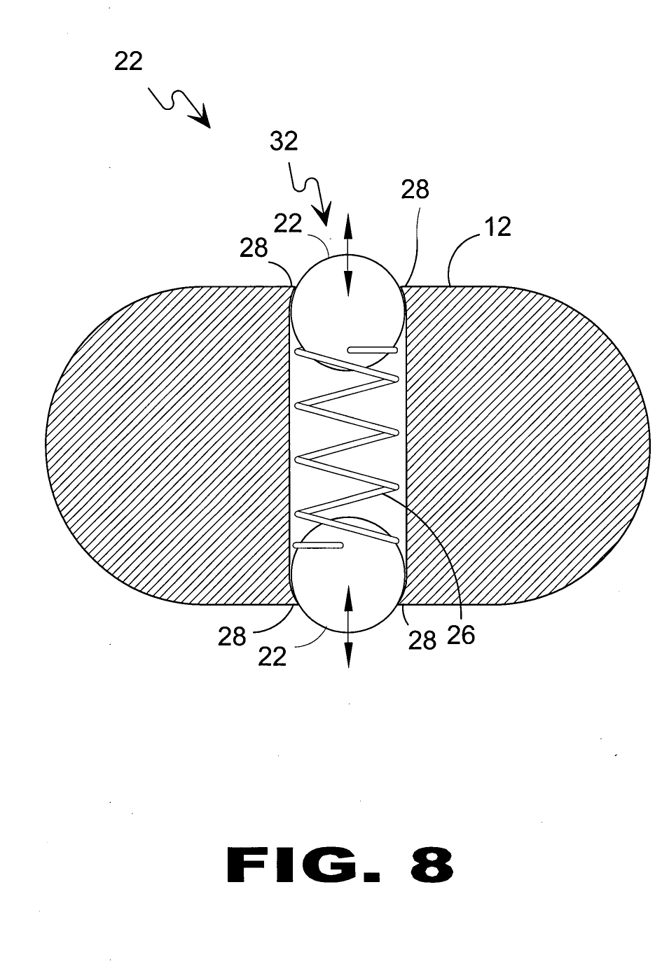

Referring to FIG. 8, shown is a sectional side view of the decorative article 22 having a version of the bullet assembly 32 incorporated directly within the throughbore 30. The bullets 24 and spring 26 are maintained in the throughbore 30 by the retaining lips 28.

What is claimed is new and desired to be protected by Letters Patent is set forth in the appended claims:

1. An eyeglass frame having a temple arm with a transverse aperture forming means for receiving an interchangeable decorative article therein.

2. The eyeglass frame as recited in claim 1, wherein said eyeglass frame has a pair of temple arms and wherein said transverse aperture is formed in at least one of the temple arms.

3. The eyeglass frame as recited in claim 1, wherein said frame has a pair of temple arms and wherein said transverse aperture is formed in both of said temple arms.

4. The eyeglass frame as recited in claim 2, wherein said frame has a pair of temple arms with at least one said arm having a plurality of transverse apertures disposed therein.

5. The eyeglass frame as recited in claim 3, wherein said eyeglass frames having a pair of temple with each having a plurality of said transverse apertures formed therein.

6. The eyeglass frame as recited in claim 1, wherein said decorative article is removable thereby enabling the placement of a desired decorative article from a group of decorative articles.

7. The eyeglass frame as recited in claim 1, wherein said decorative article is rotatively fixed within said transverse aperture.

8. The eyeglass frame as recited in claim 7, wherein said article fixation incorporates means for mechanically bonding said decorative article within said transverse aperture.

9. The eyeglass frame as recited in claim 8, wherein said mechanical bonding means is a flexi-pin assembly comprising:
a) a throughbore extending through said decorative article;
b) a spring member disposed within said throughbore;
c) two bullets, each having at least one spherical end, disposed within said throughbore with a bullet at each end of said spring member having said spherical end oriented towards its respective point of egress;
d) a retaining lip disposed at the point of egress for each said bullet wherein said retaining lip has a circumference smaller than the largest circumference of said sphere; and
e) recesses disposed in the interior walls of said transverse aperture ans positioned to align with said bullets upon insertion therein.

10. The eyeglass frame as recited in claim 9, wherein each said bullet is ball-shaped.

11. The eyeglass frame as recited in claim 10, wherein said spring member provides a bias to urge said bullets out of said throughbore.

12. The eyeglass frame as recited in claim 11, wherein said bullets are refused egress by said retaining lips thereby having said bullets extending substantially therefrom when in a static state and retracting when a sufficient opposing bias is applied thereto to overcome the bias presented by said spring.

13. The eyeglass frame as recited in claim 12, wherein said decorative article is sized to fit within said transverse aperture while said bullets extend beyond the walls thereof.

14. The eyeglass frame as recited in claim 11, wherein said decorative article is installed by inserting it into said transverse aperture so the walls thereof make contact with the curved surfaces of said bullets thereby urging them into said throughbore due to the pressure applied by the user pushing the decorative member therein thus enabling the continued insertion therein.

15. The eyeglass frame as recited in claim 14, wherein said bullets extend into said recesses once aligned therewith thereby forming the mechanical bond to retain said decorative article in position.

16. The eyeglass frame as recited in claim 15, wherein said decorative article is rotative when installed.

17. The eyeglass frame as recited in claim 16, wherein said temple arm aperture is available in a plurality of shapes and sizes.

18. The eyeglass frame as recited in claim 17, wherein said temple arm aperture is surrounded by a decorative collar.

19. The eyeglass frame as recited in claim 1, wherein said decorative article is selected from the group including a bead, semi-precious stone and precious stone.
